(19) United States
(12) Patent Application Publication
(10) Pub. No.: US 2019/0284399 A1
(43) Pub. Date: Sep. 19, 2019

(54) STORAGE-STABLE POLYMER-BONDED COATING COMPOSITIONS

(71) Applicant: STO SE & Co. KGaA, Stühlingen (DE)

(72) Inventors: Michael Troll, Bonndorf-Dillendorf (DE); Jack van Leeuwen, Zofingen (CH); Gerald Burgeth, Eggingen (DE)

(21) Appl. No.: 16/285,751

(22) Filed: Feb. 26, 2019

Related U.S. Application Data
(60) Provisional application No. 62/642,852, filed on Mar. 14, 2018.

(51) Int. Cl. C09D 5/02; C09D 7/61

(52) U.S. Cl. CPC C09D 5/022; C09D 7/61; C09D 5/025; C09D 5/028

(57) ABSTRACT

The invention concerns a storage-stable polymer-bonded composition for the formation of coatings on buildings and the like, comprising at least one organic binder, at least one filler and/or pigment, water in order to produce a pasty consistency in the composition, a buffer system which comprises at least one basic silicate, at least one substance which retards the condensation of the basic silicate, as well as optional conventional additives.

### RELATED APPLICATION

This application claims priority to U.S. Provisional application Ser. No. 62/642,852, filed on Mar. 14, 2018, the entire contents of which are hereby incorporated by reference.

The invention relates to storage-stable polymer-bonded compositions for the formation of coatings on buildings and the like, comprising at least one organic binder, at least one filler and/or pigment, water in order to produce a pasty consistency in the composition, a buffer system which comprises at least one basic silicate, at least one substance which retards the condensation of the basic silicate, as well as optional conventional additives.

### TECHNICAL FIELD OF THE INVENTION

Compositions of the type in accordance with the invention are aqueous, pasty mixtures for the formation of coatings on buildings. Between manufacturing them and using them, they often have to withstand periods of weeks or months of storage, during which they must not change significantly. Because of the organic binder content which is in an aqueous medium, there is a risk that the compositions could be attacked by eukaryotic microbes which feed off the binder and other organic additives. This could render the affected composition useless and therefore has to be effectively prevented.

Thus, preserving such solutions and protecting them against microbial attack is already known.

The use of conventional preservatives in this regard cannot generally be considered, because they are increasingly subject to legal constraints.

Thus, the generation of storage-stable compositions of the type considered here containing no conventional preservatives has already been proposed, in which the pH of the composition is raised in a manner such that the microbial attack is effectively prevented. A pH of at least 10 is envisaged in this regard, because at lower pHs, the microbial attack cannot be prevented with sufficient certainty.

Thus, in the prior art, the pH is raised by adding water glass, for example in accordance with EP 1 297 079 A1 or EP 2 905 268 A1, the disclosures of which are hereby incorporated into this description by reference.

Finding a functional and commercially useful system for raising the pH in such compositions is no trivial task.

Raising the pH, for example by adding alkaline solutions such as NaOH or KOH, is not enough. The pH drops again within a few days or weeks, and so the protection against attack diminishes. A buffer with sufficient buffer capacity is required.

Coatings containing water glass as described in EP 1 297 079 A1 or EP 2 905 268 A1 essentially contain such suitable buffer systems. However, they suffer from considerable disadvantages when applied to critical substrates. With critical substrates, in particular with absorbent, basic substrates, especially cementitious substrates, the water glass-containing coating dries out too quickly because the silicification reaction is accelerated by the basic nature of the substrate. After the water glass comes into contact with the basic substrate, an immediate reaction takes place with the “reactive” components of the substrate (Ca(OH)₂, basic silicates and/or (siliceous) fillers with surface OH groups). This silicification reaction starts immediately, and so penetration into the substrate is compromised.

Critical substrates, in particular basic absorbent substrates, are often not homogeneously critical or absorbent. Sites or regions exist which are critical or absorbent to a greater or lesser extent. This leads to spotting if the substrate is not “homogenised” by pre-treatment (priming and/or fluating). “Fluating” is the neutralisation and hardening of alkaline substrates by application of a fluate, which is a salt of hexafluorosilicic acid (fluorosilicates).

When using water glass-containing coatings on old purely polymer-bonded coatings, problems also arise with adhesion, unless the substrate has been appropriately pre-treated. Silicification with the substrate cannot take place.

There therefore exists a need for improved systems for sufficiently and durably raising the pH in compositions in accordance with the invention.

Such systems must provide sufficiently high pHs in the compositions over sufficient lengths of time. They must be compatible with the other components of the compositions and must not compromise their usefulness. They must satisfy legal requirements and should be as easy as possible to use and be capable of being produced cost-effectively.

Furthermore, an essential objective of the invention is to provide coatings which enable drying on critical substrates to take place without spotting, without the need for a pre-treatment of the substrate.

These coating compositions should be as easy to apply as comparable conventional silicate-based emulsion paints or emulsion paints.

### Definitions

The term “calcareous” as used in this application should be understood to mean calcium oxide, hydroxide and/or carbonate.

In the context of the invention, the composition is considered to be storage-stable if its pH varies by no more than 1 upon storage under normal conditions for at least 30 days.

In the context of the invention, “basic silicates” are silicates which react in a highly alkaline manner upon contact with H₂O because of the presence, on the surface of the silicates, of at least one base function with a base strength of less than 5 (pKb <5). The “basic silicates” include basic alkali and alkaline-earth silicates.

Basic silicates contain at least one of the following basic groups and/or ions on the surface:

| | |
|---|---|
| free oxide ions (O²⁻), | pK_{b} = −15 |
| free hydroxide ions (OH⁻), | pK_{b} = −1.8 |

Orthosilicate groups or ions:

| | |
|---|---|
| SiO₄⁴⁻ | pK_{b} = 0 |
| HSiO₄³⁻ | pK_{b} = 1 or SiO₄³⁻ groups |
| H₂SiO₄²⁻ | pK_{b} = 2.2 or SiO₄²⁻ groups |
| H₃SiO₄⁻ | pK_{b} = 4.3 or SiO₄⁻ groups |

Metasilicate groups or ions:

| | |
|---|---|
| SiO₃²⁻ | pK_{b} = 2.2 |
| HSiO₃⁻ | pK_{b} = 4.5 or SiO₃⁻ groups |

Basic silicates tend to undergo condensation reactions such as, for example, the formation of agglomerates or silicification.

Unless expressly stated otherwise, in the context of the invention, a coating, composition, paint, render and the like describes both the product before it has been applied as well as the product after it has been applied. The term “coating” therefore encompasses the aqueous liquid or pasty composition prior to its application, as well as the solid coating which is dry to a greater or lesser extent that is produced by the application.

### DETAILED DESCRIPTION OF THE INVENTION

The invention provides coating compositions which, because of their high pH and high buffer capacity, counteract microbial attack effectively and durably and do not give rise to, or substantially reduce, the problem of the formation of spots or streaks when applied to critical substrates.

This is achieved by adding substances which retard the condensation reaction of the compositions containing basic silicates. Condensation is retarded by adding a water-soluble carbohydrate to the coating composition which has not yet been applied.

Thus, the invention concerns coating compositions, special dispersion coatings and emulsion paints comprising at least one basic silicate, at least one filler and/or pigment, at least one substance which retards the condensation of the basic silicate, water to produce a pasty consistency, at least one organic binder and optional conventional additives.

In the context of the invention, in preferred embodiments of the invention, the basic silicate is a basic alkaline-earth silicate, in particular calcium silicate, and/or an alkali silicate, for example lithium, sodium or potassium water glass. Particularly preferred embodiments of the invention contain both alkaline-earth silicate as well as alkali silicate.

Alkaline-earth silicates, in particular materials containing calcium silicate such as cement, cement clinker, granulated slag (slag sand) and/or hydraulic lime, are suitable. Because of their availability, Portland cement and white cement are particularly preferred.

When manufacturing the compositions in accordance with the invention, in the case of the alkaline-earth silicates, the basic silicate is used as the hydrate-free silicate, i.e. free or at least substantially free from alkaline-earth or calcium silicate hydrate (CSH) phases. This is understood not just by the person skilled in the art to mean that the alkaline-earth silicates or the materials containing alkaline-earth silicates, such as cement, are used in the non-set condition. CSH phases may be detected in a known manner, for example using X-ray diffraction.

In the aqueous composition, instead of the basic silicates, their reaction products with water are present, i.e. the corresponding weak acids, in acid-base equilibrium depending on their base strengths.

Hydrate-free calcium silicates are components of cement clinker or of cement. In the context of the invention, the terms “cement clinker” (abbreviated to clinker) and “cement” are frequently used synonymously, but more correctly, it should be noted that cement clinker is the fired component of cement which is responsible for setting and hardening with the addition of water and which supports the basic silicates.

Clink (Portland cement clinker) primarily consists of the following phases:
tricalcium silicate (alite), abbreviated in construction chemistry to C3 S (3CaO*SiO₂)
dicalcium silicate (belite), abbreviated to C2S (2CaO*SiO₂)
tricalcium aluminate, abbreviated to C3A (3CaO*Al₂O₃)
tetracalcium aluminate ferrite, abbreviated to C4AF or C4(A,F) (4CaO*Al₂O₃*Fe₂O₃) and C2(A,F).

The simplified chemical reactions of the main clinker phase with water to form calcium silicate hydrate can be written as follows:

2C3S+6H→CSH+3CH

written in full:

2(3CaO*SiO₂)+6H₂O→3CaO*2SiO₂*3H₂O+3Ca²⁺+6OH⁻

In the invention, the calcium silicate phases are of particular interest, because they cause the substantial rise in pH when mixed with water. The aluminate phases as well as the CaO are of less interest, because their reaction is not as basic as the hydrate-free silicates. This means that cements and clinkers which have a particularly high basic silicate content (more C2S phases than C3S phases) are of great significance, because this basic silicate contributes substantially more to raising the pH than CaO. It is the stronger base.

Silicate-“rich” cements and clinkers with a SiO₂ fraction of more than 10%, preferably >15% and more preferably >20%, such as Portland cement, are preferred.

However, the SiO₂ fraction must also not be too high and should be below 50%, preferably below 40%, more preferably below 30%. Otherwise, the cement condenses too quickly and is then difficult to retard.

Thus, not only can cement and clinker act as a source of the calcium silicate phases, but granulated slag (slag sand) can as well; as a rule, this consists of approximately 30-45% CaO, 30-45% SiO₂, 5-15% Al₂O₃, 4-17% MgO, 0.5-1% S and traces of other elements.

Granulated slag is highly suitable, not only because of the high SiO₂ content, but especially also because of the fact that granulated slag is a latent hydraulic binder. “Latent” means that granulated slag is relatively inert and does not set quickly. Because the basic silicate is not used as a binder and setting of this hydraulic additive is not desired, granulated slag is highly suitable. However, it is substantially more expensive than cement/cement clinker. For reasons of cost, the use of Portland cement, white cement or corresponding composite cements is preferred.

In the broadest embodiment, alkali silicates (Li, Na, K water glass, silica sols) and/or the hydrate-free alkali silicates (solid water glass) may be used as the basic silicates.

Coating masses containing water glass (alkali silicate) possess only a relatively short “open time”, particularly when applied to highly basic substrates (containing cement or calcareous). Silicification to the substrate, which is a condensation reaction, takes place very rapidly.

It has been known for a very long time that water glass (alkali silicates) acts on cement (containing alkaline-earth silicates) as an accelerator, and vice versa. Setting of the cement or silicification of the water glass occur immediately and rapidly with this combination. This may also be the reason why water glass-containing coating compositions silicify immediately on cementitious substrates, i.e. immediately bind to the substrate in a condensation reaction with the “reactive” components of the substrate (Ca(OH)₂, other basic silicates and/or (siliceous) fillers with surface OH groups, and the “open time” is very short. The coating composition sets immediately, which is not always desirable in the case of a paint. Application is made more difficult. “Exsiccation” of the paint occurs, inter alia, and the paint is not applied evenly. Spots or regions exist which are critical or absorbent to greater or lesser extents. This results in spotting if the substrate is not “homogenised” by pre-treatment (priming and/or fluating).

Compositions which contain both alkali and alkaline-earth silicates cause particular problems because they set too quickly.

The combination of alkali and alkaline-earth silicates is usually practically impossible. In coating compositions containing cement and water glass, both the cement and the water glass bind while still in the bucket.

The combination of alkali and alkaline-earth silicates in aqueous paints is thus unknown. Such paints would bind while still in the bucket. The use of alkaline-earth silicates alone (i.e. of aqueous paints with a cement content) is also unknown. Here again, the cement setting process would commence immediately and the composition would thicken in the pot.

This prohibits the use of basic silicates as a buffer system in compositions in accordance with the invention. This is the case even though the basic silicate content required for buffering is much lower than that required for a structural function of the silicate. Even at low contents which are still sufficient for a buffer system, a condensation or setting of the basic silicate would result in compromising the consistency. The composition would not in fact become solid, but rather would become too thick.

The quantities of basic silicates employed are small. A function as a binder is therefore excluded. They function only as an additive for raising the pH and as a basic buffer.

Preferably, the contents in the buffer system are measured in a manner such that they are sufficient to produce and maintain a pH of at least 10 in the composition over at least 30 days, preferably 60 days, more preferably 90 days, yet more preferably 180 days, especially preferably 360 days and more especially preferably 720 days.

In preferred embodiments, the basic silicate comprises both alkaline-earth silicate as well as alkali silicate.

In preferred embodiments, the basic silicate content is a maximum of 2% by weight, preferably at least 0.01% by weight, more preferably between 0.01 and 1% by weight, most preferably between 0.01 and 0.5% by weight, with respect to the total weight of the composition. In preferred embodiments, the substance which retards the setting or silicification (condensation) of the basic silicate is a water-soluble carbohydrate which is preferably selected from saccharides such as, in particular, mono-, di- and oligo-saccharides, especially from sugars, amino sugars and deoxy sugars. Mono- and di-saccharides as well as household sugar (saccharose) and/or glucosamine are particularly preferred. Furthermore, hydroxycarboxylic acids such as, in particular, saccharic acids and their salts and derivatives may be used. Polysaccharides such as starch as well as other carbohydrates which are used in the prior art as thickeners are less suitable or even unsuitable as setting retardants due to their poor solubility.

Preferred embodiments of the invention have a content of a maximum of 1.0% by weight, preferably at least 0.001% by weight, more preferably between 0.005% by weight and 0.5% by weight, yet more preferably between 0.005% by weight and 0.1% by weight and most preferably between 0.01% by weight and 0.08% by weight of at least one water-soluble carbohydrate, with respect to the total weight of the composition.

Preferred embodiments of the invention have a content of at least one organic binder of between 1% by weight and 40% by weight, preferably between 2% by weight and 30% by weight, particularly preferably between 2.5% by weight and 25% by weight, respectively calculated as a solid.

Preferably, compositions in accordance with the invention comprise a content of at least one filler and/or pigment of between 10% by weight and 90% by weight, preferably between 20% by weight and 85% by weight, particularly preferably between 25% by weight and 80% by weight.

The water content of the composition is preferably between 5% by weight and 50% by weight.

The at least one organic binder is preferably selected from the group which comprises homopolymers, copolymers or terpolymers of acrylic acid and/or methacrylic acid, itaconic acid as well as acid esters such as ethyl acrylate, butyl acrylate; styrene, substituted or unsubstituted vinyl chloride, vinyl acetate, vinyl propionate, ethylene, butadiene, versatate, acrylamide and acrylonitrile; water-soluble alkyd polymers, combinations of (meth)acrylic/alkyd polymers, polyvinyl alcohol and mixtures thereof, wherein homopolymers or copolymers of acrylic acid and/or methacrylic acid are preferred. Aqueous polymer dispersions which are sufficiently stable to saponification are generally preferred.

Furthermore, silicone resins and polysiloxanes may also be used as binders.

The at least one filler or pigment is preferably selected from the group which comprises pyrogenic precipitated silica, precipitated silica, silicon-aluminium mixed oxides, alkaline-earth carbonates such as calcium carbonate, silicon dioxide, silicates, for example aluminosilicates, sulphates, such as barium sulphate, titanium dioxide, color pigments, for example iron oxide, bismuth vanadate or mixtures thereof, wherein titanium dioxide, silicates and carbonates are preferred.

Preferably, compositions in accordance with the invention contain at least one additive such as, for example, a rheological additive, a defoaming agent, a hydrophobicity agent, a wax or a wax preparation, a stabilizer, fibres, a film-forming agent and a dispersant and wetting agent.

The compositions in accordance with the invention may advantageously be used in order to produce a render, a paint, in particular an emulsion paint, a decorative final coating or the like.

The compositions in accordance with the invention have a pH of at least 10.5, preferably at least 11, over at least 30 days, preferably at least 60 days, more preferably 90 days, yet more preferably 180 days, especially preferably 360 days and more especially preferably 720 days.

### Exemplary Embodiment 1: Emulsion Paint

| | | |
|---|---|---|
| water | 28 | parts by weight |
| aqueous polymer dispersion (approx. 50% | 30 | parts by weight |
| solid content) | | |
| fillers and pigments | 37 | parts by weight |
| basic silicates | 0.5 | parts by weight |
| sugar | 0.05 | parts by weight |
| additives (in particular rheological additives, | 5 | parts by weight |
| hydrophobicity agents, defoaming agents, | | |
| film-forming agents, fibres, dispersants, etc) | | |

The pH of this paint formulation was 11.6; after 16 weeks, it was in fact 11.7.

### Exemplary Embodiment 2: Dispersion Silicate Paint

| | | |
|---|---|---|
| water | 33 | parts by weight |
| aqueous polymer dispersion (approx. 50% | 8 | parts by weight |
| solid content) | | |
| fillers and pigments | 54 | parts by weight |
| basic silicates | 1.5 | parts by weight |
| sugar | 0.05 | parts by weight |
| additives (in particular rheological additives, | 4 | parts by weight |
| hydrophobicity agents, defoaming agents, | | |
| film-forming agents, fibres, dispersants, etc) | | |

The pH of this paint formulation was 11.1; after 16 weeks, it was still 11.0.

The rheological properties (viscosity) during this time period remained practically unchanged. No microbial attack could be detected sensorially. The compositions of the exemplary embodiments had been shown to be storage-stable.

What is claimed is:

1. A storage-stable polymer-bonded composition for the formation of coatings on buildings and the like,
comprising at least one organic binder, at least one filler and/or pigment, water in order to produce a pasty consistency in the composition, a buffer system which comprises at least one basic silicate, at least one substance which retards the condensation of the basic silicate, as well as optional conventional additives.

2. The composition as claimed in claim 1, wherein the contents are measured in a manner such that they are sufficient to produce and maintain a pH of at least 10 in the composition over at least 30 days, preferably 60 days, more preferably 90 days, yet more preferably 180 days, especially preferably 360 days and more especially preferably 720 days.

3. The composition as claimed in claim 1,
characterized in that the basic silicate comprises an alkaline-earth silicate, preferably calcium silicate.

4. The composition as claimed in claim 1, in which the alkaline-earth silicate is in the form of a cement in which preferably, the proportion of SiO₂ is more than 10% by weight, preferably >15% by weight, more preferably >20% by weight, and especially less than 50% by weight, more especially less than 40% by weight, yet more especially less than 30% by weight.

5. The composition as claimed in claim 1,
characterized in that the basic silicate comprises an alkalis a preferably water glass.

6. The composition as claimed in claim 1,
characterized in that the basic silicate content is a maximum of 2% by weight, preferably at least 0.01% by weight, more preferably between 0.01 and 1% by weight, most preferably between 0.01 and 0.5% by weight, with respect to the total weight of the composition.

7. The composition as claimed in claim 1,
characterized in that the condensation-retarding substance is a water-soluble carbohydrate which is preferably selected from saccharides such as, in particular, mono-, di- and oligo-saccharides, especially from sugars, amino sugars and deoxy sugars, particularly preferably from mono- and di-saccharides as well as household sugar (saccharose) and/or glucosamine; and from hydroxycarboxylic acids such as, in particular, saccharic acids and their salts and derivatives.

8. The composition as claimed in claim 7,
characterized in that the carbohydrate comprises household sugar and/or glucosamine.

9. The composition as claimed in claim 1,
characterized by a content of a maximum of 1.0% by weight, preferably at least 0.001% by weight, more preferably between 0.005% by weight and 0.5% by weight, yet more preferably between 0.005% by weight and 0.1% by weight and most preferably between 0.01% by weight and 0.08% by weight of coagulation-retarding substance, with respect to the total weight of the composition.

10. The composition as claimed in claim 1,
characterized by a pH of at least 10.5, preferably at least 11, over at least 30 days, preferably at least 60 days, more preferably 90 days, yet more preferably 180 days, especially preferably 360 days and more especially preferably 720 days.

11. The composition as claimed in claim 1,
characterized by a content of at least one organic binder of between 1% by weight and 40% by weight, preferably between 2% by weight and 30% by weight, particularly preferably between 2.5% by weight and 25% by weight, respectively calculated as a solid.

12. The composition as claimed in claim 1,
characterized by a content of at least one filler and/or pigment of between 10% by weight and 90% by weight, preferably between 20% by weight and 85% by weight, particularly preferably between 25% by weight and 80% by weight.

13. The composition as claimed in claim 1,
characterized by a water content of between 5% by weight and 50% by weight.

14. The composition as claimed in claim 1,
characterized by a content of at least one organic binder selected from the group which comprises homopolymers, copolymers or terpolymers of acrylic acid and/or methacrylic acid, itaconic acid as well as acid esters such as ethyl acrylate, butyl acrylate; styrene, substituted or unsubstituted vinyl chloride, vinyl acetate, vinyl propionate, ethylene, butadiene, versatate, acrylamide and acrylonitrile; water-soluble alkyd polymers, combinations of (meth)acrylic/alkyd polymers, polyvinyl alcohol and mixtures thereof, wherein homopolymers or copolymers of acrylic acid and/or methacrylic acid are preferred.

15. The composition as claimed in claim 1,
characterized by a content of at least one filler or pigment selected from the group which comprises pyrogenic precipitated silica, precipitated silica, silicon-aluminium mixed oxides, alkaline-earth carbonates such as calcium carbonate, silicon dioxide, silicates, for example aluminosilicates, sulphates, such as barium sulphate, titanium dioxide, color pigments, for example iron oxide, bismuth vanadate or mixtures thereof, wherein titanium dioxide, silicates and carbonates are preferred.

16. The composition as claimed in claim 1,
characterized by a content at least one additive such as, for example, a rheological additive, a defoaming agent, a hydrophobicity agent, fibres, a film-forming agent and a dispersant.

17. The composition as claimed in claim 1,
characterized in that the composition is a render, a paint, in particular an emulsion paint, a decorative final coating or the like.
